(19) United States
(12) Patent Application Publication
(10) Pub. No.: US 2026/0185403 A1
(43) Pub. Date: Jul. 2, 2026

(54) CLOSURE SYSTEM

(71) Applicant: LOCINOX, Waregem (BE)

(72) Inventor: Joseph TALPE, Heestert-Zwevegem (BE)

(73) Assignee: LOCINOX, Waregem (BE)

(21) Appl. No.: 19/434,184

(22) Filed: Dec. 29, 2025

(30) Foreign Application Priority Data
Dec. 30, 2024 (EP) 24223617.2

(51) Int. Cl. E06B 11/02; E05F 3/18; E05F 15/611; E06B 11/04

(52) U.S. Cl. CPC E06B 11/022; E05F 3/18; E05F 15/611; E06B 11/04; E05Y 2201/254; E05Y 2201/422; E05Y 2201/47; E05Y 2600/41; E05Y 2800/24

(57) ABSTRACT

A closure system comprising: a pivotable gate (3); a gate post extending in an upright direction and comprising: a mounting foot configured to be mounted on a ground surface; and a bearing frame (11) extending in the upright direction with the pivotable gate being hingedly connected to the bearing frame, the bearing frame comprising at least two support members (52) which are located on opposite sides of the bearing frame; a mainly L-shaped actuator (4a, 4b) which is at least partially positioned inside the bearing frame and comprises: an output member (20, 21) engaging the pivotable gate; and further support members (55), wherein the actuator is supported inside the bearing frame by intercoupling of the support members. By virtue of the support members, the gate post and actuator can be readily assembled without requiring complex operations by common fixation elements.

### TECHNICAL FIELD

The present invention relates to a closure system and a method for at least partially assembling the closure system.

### Background Art

In the field of outdoor closure systems there are generally two kinds of gate posts, namely a support gate post on which the closure member is attached and a free gate post against which the closure member closes. In view of their different functions, the gate posts are usually different in size, shape, material, rigidity, etc.

In the context of support gate posts, there are various ways on how to mount the closure member to the gate post. This may involve rail assemblies, hinge assemblies, gate closers, gate actuators, etc. Moreover, for each assembly, various kinds exist. For example, hinges may be front mounted, rear mounted, or side mounted. Gate closers may act on the closure member or on the hinge. The gate may be centrally aligned with respect to the gate posts, but other alignments are known, e.g. front or rear alignment.

Furthermore, different types of gate actuators are known in the art, for example spring-biased gate actuators as disclosed in WO 2012/103572 that are intended solely for closing the gate; hydraulically damped spring-biased gate actuators as disclosed in WO 2018/228729 that are intended solely for closing the gate; and motorized gate actuators which are operated by an electric drive as disclosed in WO 2019/048359 that are intended for opening and closing the gate. Due to the use of an electric drive, which thus serves for both the opening and closing of the gate, this kind of gate actuator is also often referred to by the term “gate opener”.

Moreover, there are various configurations known on where and how to provide the electric drive for the gate actuation. Commonly, the drive is provided separately from the closure system, e.g. adjacent the closure system or positioned in a dedicated space in the ground. The drive can also be provided on the outside of the gate post, e.g. as disclosed in WO 2019/048359, or integrated in the gate post, e.g. as in EP b 2 966 251.

In general, due to the number of possible configurations of closure systems and consumer demands, manufacturers and retailers are required to have a large stock of parts in order to meet consumer needs. There is also a large amount of customization and on-site assembly required especially when replacing a closure system in an already present enclosure.

### Disclosure of the Invention

It is an object of the present invention to provide a closure system which at least partially alleviates one or more of the above-mentioned disadvantages.

According to the present invention, this is achieved with a closure system comprising: a pivotable gate; a gate post extending in an upright direction between a lower end and an upper end, the gate post comprising: a mounting foot provided at the lower end of the gate post and being configured to be mounted on a ground surface; a bearing frame extending in the upright direction between a lower end and an upper end with the pivotable gate being hingedly connected to the bearing frame, the bearing frame comprising a first set of support members near its upper end and comprising at least two support members which are located on opposite sides of the bearing frame; an actuator which is at least partially positioned inside the bearing frame, the actuator being mainly L-shaped with a first leg extending in the upright direction between a lower end and an upper end and a second leg extending from the lower end outwards in a transverse direction which is perpendicular to the upright direction, the actuator comprising: an output member provided in the second leg with the pivotable gate engaging the output member; and a second set of support members which corresponds to said first set of support members, wherein the actuator is supported inside the bearing frame by intercoupling of the first and second sets of support members.

The present invention provides a ground mounted gate. The actuator is integrated in the gate post, which gate post comprises the mounting foot and the bearing frame. By virtue of the support members, the gate post and actuator can be readily assembled without requiring complex operations (e.g. milling, welding, etc.) by common fixation elements (e.g. bolts, nuts, screws, etc.).

Another advantage of the present invention is that the pivotable gate directly engages the output member of the actuator. There is thus no need for a transmission mechanism.

In practice, the connection between the bearing frame and the ground surface on which it is mounted is of paramount importance since all forces exerted on the bearing frame have to be transferred via the mounting foot to the ground surface. According to the present invention, there is a direct connection between the bearing frame and the mounting foot reducing the risk of intermediate elements not being able to handle the forces involved. The direct connection also inherently involves overlapping and adjacent wall sections of the bearing frame and the mounting foot thereby creating a large contact area improving force transfer and reducing local pressure.

An embodiment of the present invention is characterised in that the actuator is adjustable with respect to the bearing frame in the transverse direction. Preferably, this adjustability may be achieved in that the first and second sets of support members form a sliding interlock, such as a T-slot or a dovetail, extending in the transverse direction. The tongue section of the sliding interlock is advantageously provided on the first set of support members.

As the pivotable gate is directly connected to the actuator, it is advantageous to allow adjusting the position of the actuator with respect to bearing frame. More specifically, the clearance between the pivotable gate and the gate post is determined by the placement of the actuator with respect to the mounting foot. As such, adjusting this distance, allows to adjust the gate-gate post clearance. The use of a sliding interlock (e.g. a T slot, a dovetail groove, etc.) is a convenient manner to allow such a sliding motion, in particular in a near continuous manner, whilst maintaining the essential function of the support members (i.e. preventing that the actuator can move in any other direction with respect to the bearing frame).

Providing the tongue section of the sliding interlock as part of the first support members, i.e. as part of or on the bearing frame, is desired from a practical point of view. More specifically, the reverse situation where the groove section is provided on the bearing frame requires a less compact design. For example, the bearing frame should have a sufficiently thick wall to provide a groove therein or a relatively high rail should be provided which is high enough to provide the groove with adjacent space for fastening to the bearing frame. Whereas the tongue section can be more easily be provided by a thin rail element.

An embodiment of the present invention is characterised in that a spacer is provided between the bearing frame and one of said at least two support members, the spacer extending in a direction which is perpendicular to the upright direction and to the transverse direction, the spacer preferably being cut at length from an extrusion profile.

The provision of a spacer allows to adjust the actuator with respect to the bearing frame in the depth direction. More specifically, the alignment between the pivotable gate and the gate post is determined by the placement of the actuator with respect to the bearing frame in the depth direction. The spacer thus allows to provide a central alignment, a front or rear alignment or generally any desired alignment.

Cutting the spacer at length from an extrusion profile allows for an exact and custom alignment to be achieved which may be particularly advantageous in case of an installation in an existing enclosure where a gate stop may already be installed in the ground.

n embodiment of the present invention is characterised in that the actuator is substantially watertight.

This reduces the risk of water infiltration which may lead to malfunctions or reduced functionality of the actuator.

An embodiment of the present invention is characterised in that the bearing frame is provided with a plurality of sets of fixation openings, each set being spaced apart from an adjacent set in the upright direction and comprising two groups of openings with each group being provided in an opposite wall of the bearing frame, each group comprising two or more openings which are aligned in the transverse direction.

The use of sets of fixation openings allows readily assembling the gate post without requiring complex operations (e.g. milling, welding, etc.) by common fixation elements (e.g. bolts, nuts, screws, etc.). The various connections are also formed between two opposite walls creating a steady and robust closure system. This further reduces the risk of misaligning certain elements and reduces the risk of torsional force effects occurring.

A preferred embodiment of the present invention is characterised in that the mounting foot and/or the first set of support members are fixed to the bearing frame by a plurality of fixation elements which each extend through one of the fixation openings that are part of said plurality of sets of fixation openings. Other components, such as the spacer, a top cover, etc. are also preferably fastened to the bearing frame using fixation elements which each extend through one of the fixation openings.

The fixation openings and fixation members allows readily assembling the support members and mounting foot to the bearing frame without requiring complex operations (e.g. milling, welding, etc.) by common fixation elements (e.g. bolts, nuts, screws, etc.).

A preferred embodiment of the present invention is characterised in that the fixation elements used to fix the first set of support members to the bearing frame are provided with a spring washer.

An actuator, especially an electrically operated actuator, may cause vibrations during use. The provision of spring washers reduces the risk that such vibrations may cause the fixation elements to become loose.

A preferred embodiment of the present invention is characterised in that each of said plurality of sets of fixation openings are identical and are preferably uniformly distributed along an upwards extending section of the bearing frame.

The use of identical sets of openings allows relying on a same fixation pattern at different locations and/or for different elements. Providing uniform sets of openings allows reusing a same manufacturing pattern to form different lengths of bearing frames in a simple and expedient manner.

A preferred embodiment of the present invention is characterised in that the first set of support members comprises at least two support members that are spaced in the upright direction on each of said opposite sides of the bearing frame.

Providing multiple sets of support members creates multiple connections between the actuator and the bearing frame at various heights thus creating a stronger gate post-actuator assembly.

An embodiment of the present invention is characterised in that the mounting foot is provided at its lower end with one or more flanges, each flange having one or more openings configured to receive a fastening member to fasten the mounting foot to the ground surface.

The flanges provide a large support area for placing the mounting foot in a stable manner. The provision of the fastening openings again reduces needlessly complex operations during installation of the closure system.

An embodiment of the present invention is characterised in that the output member of the actuator comprises a rotatable arm fixed to the pivotable gate; and a shaft which forms a pivot axle for the pivotable gate.

Whilst the output member can generally be either an output protrusion or a toothed opening, providing the protrusion on the actuator is advantageous. This causes a space reduction for the second leg of the actuator which can thus be generally made thinner with the output protrusion sticking out in the upwards direction. The rotatable arm acts as a load arm to reduce the force required to move the gate.

An embodiment of the present invention is characterised in that the actuator comprises: a drive mechanism forming mainly said first leg, the drive mechanism comprising one of: a spring biased mechanism, a hydraulically damped spring biased mechanism, and an electric motor; and a transmission forming mainly said second leg.

An electric motor is preferred as this provides a closure system that can be opened and closed in an automated manner, making it very suitable to acts as a vehicle passage.

A preferred embodiment of the present invention is characterised in that the second set of support members are located substantially between the drive mechanism and the transmission mechanism and particularly adjacent an output shaft of the drive mechanism.

This placement allows to maintain a compact as possible actuator. Placing the support members (more specifically T-slot or dovetail grooves) in a housing section surrounding the drive mechanism output shaft relies on the space available around the drive shaft without requiring an increase in horizontal dimensions of the actuator.

An embodiment of the present invention is characterised in that the gate post further comprises a top cover and/or an actuator top cover.

This top covers protect the actuator from atmospheric conditions and may advantageously be fixed to the bearing frame using the above mentioned fixation openings. The covers may also be provided with the same surface finish treatment as the other closure system components, e.g. the gate, the bearing frame, etc.

An embodiment of the present invention is characterised in that: the pivotable gate is rotatable with respect to the gate post over an angle of at least 150°; and/or the pivotable gate has a closed position and is rotatable with respect to this closed position in two different rotational directions to two distinct open positions.

Both embodiments in essence amount to the same advantageous closure system where the pivotable gate can open in both rotational directions. This is especially beneficial for pedestrian gates as the gate can then always swing away from the pedestrian. In particular for people with a mobility disorder (e.g. wheelchair) it is desired that the gate swings away from them.

The present invention further relates to a method for at least partially assembling closure system described above, the method comprising:
placing the actuator inside the bearing frame; sliding the bearing frame over the mounting foot; using fixation elements to join the mounting foot, the actuator and the bearing frame together to form a gate post; and providing the gate post and the pivotable gate to be mounted on a ground surface.

This method relies on the unique advantage provided by the various parts of the closure system, namely that the entire gate post with actuator can be assembled in the manufacturing process and then transported to the installation site. This assembly is thus done in a neat and organized environment thus reducing the risk of errors occurring. The end installation can then be done by common practitioners without requiring a detailed knowledge on the gate post assembly.

### BRIEF DESCRIPTION OF THE DRAWINGS

The invention will be further explained by means of the following description and the appended figures.

Figure shows a closure system according to the present invention.

FIGS. 2A and 2B show a front and rear view respectively of the closure system shown in FIG. 1 with a focus on the gate post and with the gate post cover parts having been removed.

FIG. 3 shows an exploded view of the top part of the gate post of the closure system of FIG. 1 illustrating the relation between the bearing frame and the cover parts.

FIG. 4 shows an exploded view of the top part of the gate post of the closure system of FIG. 1 illustrating the relation between the bearing frame and the actuator.

FIG. 5A shows a perspective view of a closure system according to the present invention.

FIG. 5B shows a top view of the closure system of FIG. 5A.

FIG. 6 shows a partially exploded view of an actuator used in a closure system according to the present invention.

FIG. 7 shows a vertical cross-section through the assembled actuator of FIG. 6

### DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under, left, right, front, back, and the like in the description and the claims are used for descriptive purposes. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “substantially” comprises variations of +/−10% or less, preferably +/−5% or less, more preferably +/−1% or less, and even more preferably +/−0.1% or less, of the specified state, as far as the variations are applicable to function in the present invention. It is to be understood that the term “substantially A” is intended to include “A”.

The invention generally relates to a closure system, in particular an outdoor closure system, which is part of an enclosure. FIG. 1 shows a closure system 1 according to the present invention comprising a support gate post 2 which acts as a support for a pivotable gate 3 (or more generally a closure member, such as a gate, a door, or a window). The gate post 2 extends along the upright direction 15 between a lower end 2a and an upper end 2b. The gate 3 is connected to the gate post 2 by means of a lower hinge 5. The upper end of the gate 3 is directly engaged by the actuator 4 which is mostly integrated in the gate post 2.

The closure system 1 illustrated in FIG. 1 is intended to be mounted directly on top of a ground surface. In other words, the lower end 2a of the gate post 2 is resting directly on the ground surface 10. However, in a non-illustrated embodiment, the lower end 2a of the gate post 2 could be sunk into the ground surface.

The lower hinge 5 in the closure system 1 can be any kind of hinge known in the art and may particularly be an eyebolt hinge for example as disclosed in EP 1 528 202, EP 2 778 331 or EP 3 162 997 the content of which are incorporated herein by reference.

The general directions and orientations are also indicated in FIG. 1. More specifically, there is the upright direction 15, the width direction 16 and the depth direction 17. These three directions 15, 16, 17 are generally substantially perpendicular to one another. The upright direction 15 in practice substantially coincides with the vertical direction. The width and dept directions 16, 17 together form a substantially horizontal plane.

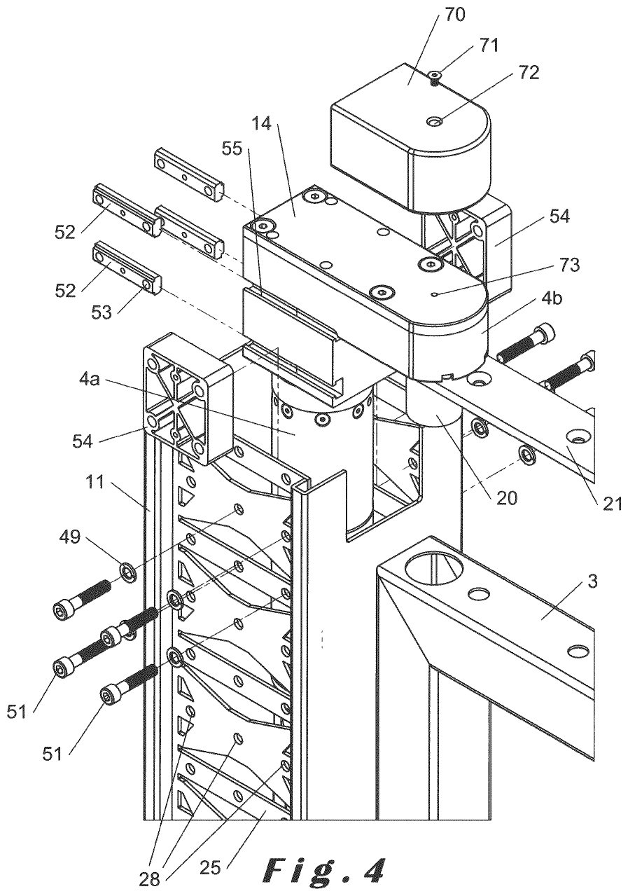

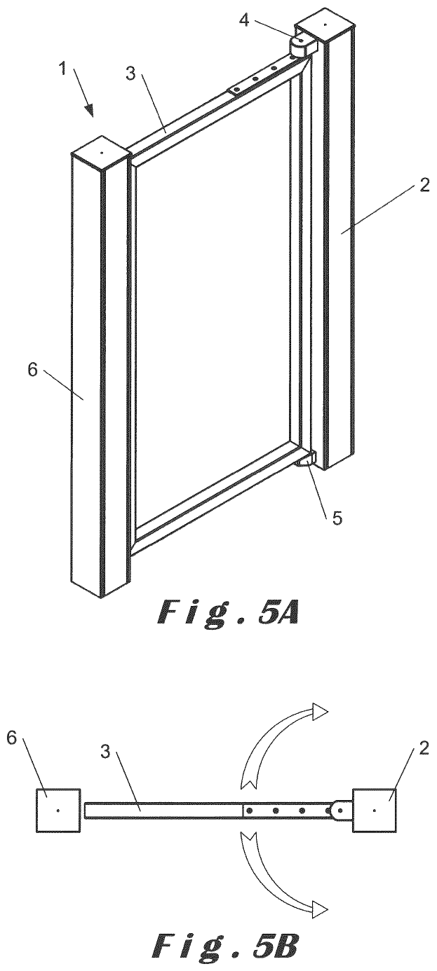

The same closure system 1 is shown in FIG. 5A. In FIG. 5A, it is shown that the closure system 1 also comprises a free gate post 6 so that a cooperating lock (not shown) and keeper assembly (not shown) may be provided. The lock may typically provided on the gate 3 and may be morticed therein as disclosed in EP 2 186 974, EP 3 153 645, and EP 4 159 962 the content of which are incorporated herein by reference. Alternatively, the lock may be surface mounted on the gate 3 as disclosed in EP 1 118 739, EP 2 915 939, and EP 4 191 007 the content of which are incorporated herein by reference. The keeper may be typically provided on the second gate post 6. The keeper may be morticed in the free post 6 or may be surface mounted on the free post 6. Examples of suitable morticed or surface mounted keepers are disclosed in EP 1 600 584, EP 3 109 381, EP 3 153 645, EP 3 239 440, EP 3 421 695, EP 4 159 962, and EP 4 245 951 the content of which are incorporated herein by reference. Examples of suitable fixture sets for fixing a surface mounted keeper to the free gate post are disclosed in WO 2007/009998 or WO 2019/228896 the content of which are incorporated herein by reference.

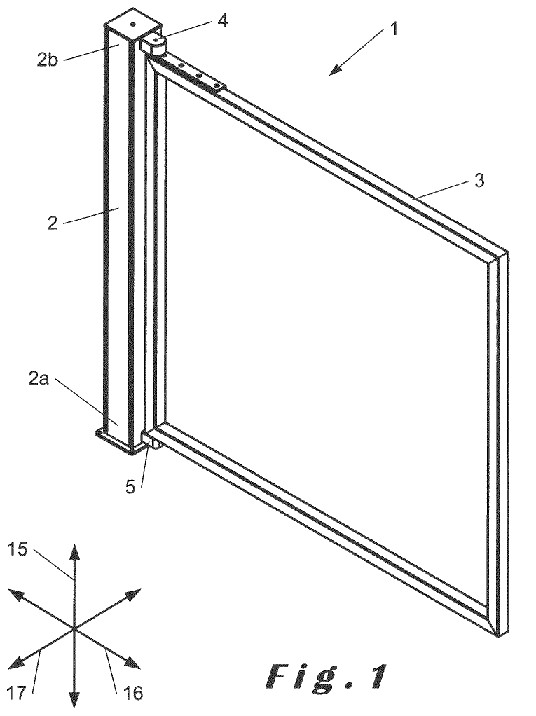

FIGS. 2A and 2B show the closure system 1 with the various cover parts (described below) having been removed. The closure system 1 comprises the following components: a pivotable gate 3, a mounting foot 10, an actuator 4, and a bearing frame 11. The mounting foot 10, the bearing frame 11 and the actuator 4 together form the gate post 2.

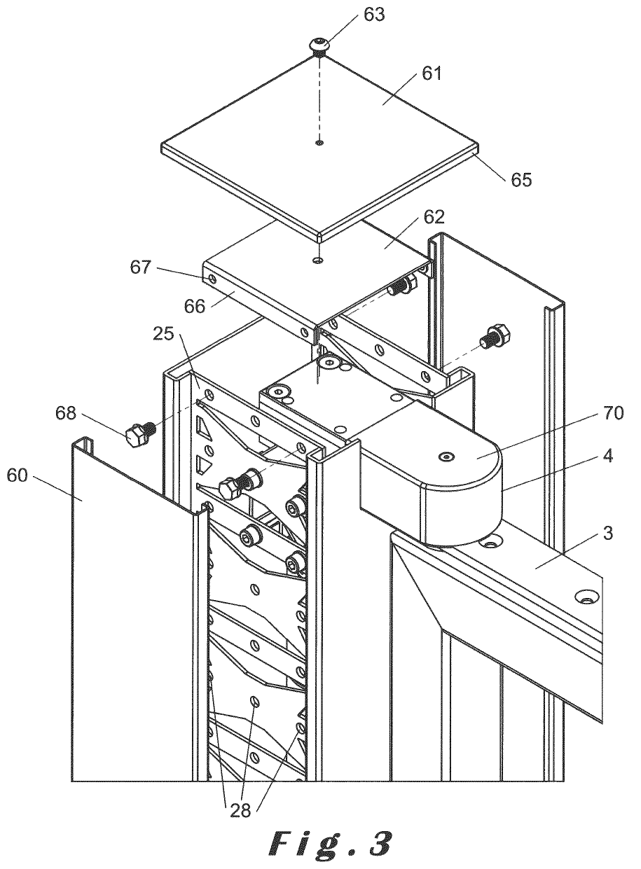

As shown in FIG. 4, the actuator 4 is generally L-shaped with a first leg 4a extending in the upright direction 15 and a second leg 4b extending in the width direction 16. The first leg 4a is integrated within the gate post 2 and the second leg 4b extends beyond the gate post 2 so that the pivotable gate 3 can engage thereon. Both legs 4a, 4b meet in an upper housing section 14.

The second leg 4b is provided with a pivot axle 20 on which the gate 3 is mounted. A rotatable arm 21 extends outwards from the second leg 4b and is fixed to the gate 3. This arm 21 transfers a rotation between the actuator 4 and the gate 3. In the illustrated embodiment, the axle 20 and arm 21 are an integrally formed component that is fixed to an output gear shaft (not shown) of the actuator 4. In other embodiments, the arm may be absent and the pivot axle 20 may be formed as a gear shaft. Moreover, it should be clear that in yet other embodiments the pivot axle 20 may also be replaced by a gear hole in which case the gear shaft is then provided on the gate 3.

In the illustrated embodiment, the actuator 4 is an electrically operated actuator comprising an electric drive and a transmission ending in the output shaft 20. The electric drive is formed by the various components in the first leg 4a, whereas the transmission is integrated within the lower housing section 14 and/or the second leg 4b. It will be readily apparent that, in other embodiments, the electric drive may be replaced by a spring-biased mechanism or a hydraulically damped spring-biased mechanism with a suitable transmission. In this way, the closure systems according to the present invention are useable for both pedestrian gates and vehicle gates.

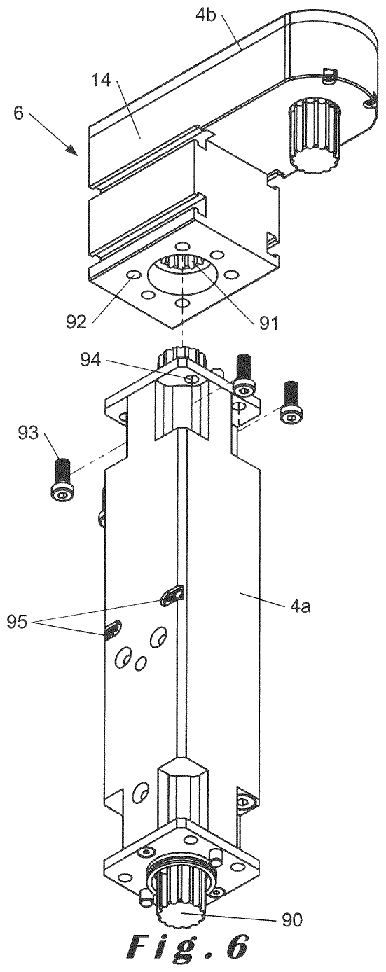

A hydraulically damped spring-biased actuator 4 is shown in exploded view in FIG. 6. The upper section of the actuator 4, i.e. the housing 14 and second leg 4b are largely unchanged. The main difference is the first leg 4a which is a different kind of drive mechanism. The hydraulically damped spring-biased mechanism 4a is fixed to the housing section 14 by means of threaded fasteners 93 which extend through fixation openings 94 into threaded areas 92 provided in the housing section 14.

Suitable hydraulically damped spring-biased mechanisms are disclosed in WO 2018/228729 and in EP 3 907 417 the content of which are incorporated herein by reference. The damper shaft 90 of these hydraulically damped spring-biased mechanisms has two end which are readily accessible and can both engage in the gear hole 91 provided in the upper housing 14. Depending on the orientation of the hydraulically damped spring-biased mechanism 4a (i.e. either upright or upside down), the mechanism 4a is operable for both right-handed and left-handed gates 3. As disclosed in WO 2018/228729, especially in FIGS. 15 to 17B, adjustment means 95 may be provided to vary the closing speed and/or end stroke of the gate 3.

It will be understood that the actuator 4 is a substantially watertight element to prevent infiltration of water which may hamper the actuator operation.

As shown in FIG. 5B, the closure system 1 may provide a saloon-effect in the sense that the closure member 3 can swing both ways with respect to the gate post 2. This is indicated with the arrows in FIG. 5B.

In general, the gate post 2 has four walls. More specifically, each gate post has: a gate facing wall which faces the closure member 3, an opposite wall facing away from the closure member 3, a front wall which normally faces outward from the enclosed area, and a back wall which normally faces the enclosed area.

The bearing frame 11 extends in the upright direction 15. The bearing frame 11 is the main structural component of the gate post 2 and as such needs to be able to bear the weight and forces associated with a closure member 3 mounted thereon. In order to achieve the desired strength and rigidity, the bearing frame 11 is generally an integrally formed component. This may be achieved by extruding the bearing frame 11 from a metal, e.g. aluminium. This may also be achieved by hot-rolling or cold-rolling a seamless metal, e.g. steel, tube. The various openings and cut-outs described later may be created by removing excess material (e.g. by laser cutting, milling, etc.) from the extruded, hot rolled or cold rolled metal tube. Various thicknesses may be used for the metal of the bearing frame 11 with suitable values being between 1 mm and 1 cm, for example 2 mm, 3 mm, 4 mm, 5 mm, 6 mm, 7 mm, 8 mm or 9 mm. The thickness depends also on the specific metal used and the manufacturing technique.

The bearing frame 11 generally has a front and back wall jointly denoted by reference number 25 and two side walls jointly denoted by reference number 26. The side walls 26 extend in the depth direction 17, whereas the front/back walls 25 extend in the width direction 16.

Another important aspect in achieving the desired strength and rigidity, is the cross-sectional shape of the bearing frame 11 in the horizontal plane. This shape is generally I shaped. This shape is caused in that the front/back walls 25 are recessed with respect to the outermost sections of the sidewalls 26. The result is that each corner of the bearing frame 11 comprises two parallel wall sections with a 180° fold. Due to this shape, each corner has a high rigidity and strength and does not easily buckle under high pressure. As an example, each parallel wall section may overlap in the depth direction 17 for about 1 cm to 3 cm and may be separated by a distance in the width direction 16 of about 0.5 cm to 2 cm. Naturally other specific dimensions are possible and linked with the material selection. This shape provides a very high rigidity thus avoiding to use very thick metal sheets (e.g. 2 cm or more) to form the bearing frame 11. Such thickness, while providing the desired strength and rigidity, would negatively impact the weight, costs, size, etc. of the bearing frame 11.

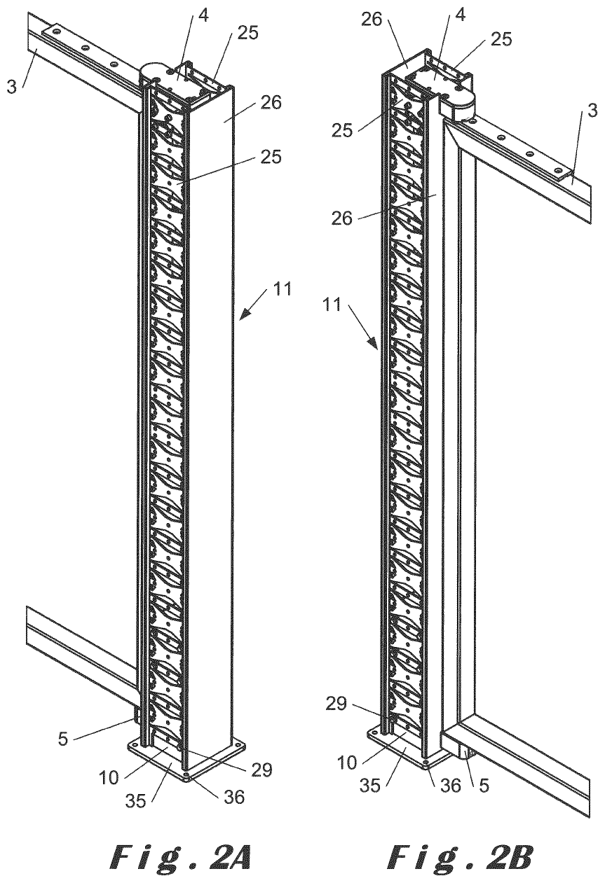

As shown in FIGS. 3 and 4, the front wall 25 forms a substantially flat area in which a repeating pattern of openings is provided. This same pattern is provided in the back wall 25 as well. This repeating pattern is disclosed in detail in the unpublished European patent application 24160956.9 incorporated herein by reference.

In relation to the closure system 1 of the present invention, the most relevant aspect of the repeating pattern of openings are the three fixation openings 28 aligned with one another in the width direction 16. It will be appreciated that the openings 28 could be misaligned with the width direction with tolerances of up to 10° offset being possible so that either the left or the right opening is higher or lower than the other. The openings 28 are symmetrical about the middle upright plane. These identical three fixation openings 28 are uniformly distributed in the upright direction 15 along the bearing frame 11 as clearly shown in FIGS. 2A and 2B. A separation in the upright direction 15 between each three fixation openings 28 may generally be about 2 cm, about 3 cm or about 4 cm. This allows identical structural end/or functional components to be fixed on the bearing frame 11 at different height locations without modification.

As used herein, the term “set of fixation openings” is intended to refer to at least two openings one of which is in the front wall of the gate post and one of which is in the back wall of the gate post, the two openings being aligned with one another in the upright direction 15 and the width direction 16. For example, a set of fixation openings in the bearing frame is thus intended to refer to one of the three openings 28 in the front wall 25 and its corresponding one in the back wall 25 which is located at the same height and width position.

Each fixation opening 28 is dimensioned to receive a threaded fastening member. In this context, the use of circular openings 28 is advantageous, albeit not necessary. In the illustrated embodiment, the openings 28 are dimensioned to receive M8 threaded fastening members.

In order to connect the bearing frame 11 with the ground surface on which the gate post 2 is mounted, a mounting foot 30 is provided. The mounting foot 30 is shown in FIGS. 2A and 2B and is intended to be placed on top of the ground surface. The mounting foot 30 extends in the upright direction 15 between a lower end and an upper end. The lower end is provided with a flange 35. This flange 35 may be continuous as illustrated in FIGS. 2A and 2B or may be split in several parts. Several fixation openings 36 are provided in the flange 35. This flange 35 with fixation openings 36 is used to mount the foot 30.

The mounting foot 30 has a front wall and a back wall which both extend in the upright direction 15. In the front/back walls, various fixation openings are provided. These openings follow the same pattern as that in the bearing frame 11. Once the bearing frame 11 is slid onto the mounting foot 30, fixation members 29 are used to fix these components together. The mounting foot 30 is preferably at least 10 cm or 15 cm high so that multiple opening pairs overlap between the mounting foot and the bearing frame 11 to ensure a strong connection between the bearing frame 11, 11′ and the mounting foot 30. This is further aided by the large contact surface area between the walls of the mounting foot 30 and the walls of the bearing frame 11.

It will be readily appreciated that the mounting foot is to be broadly interpreted and can be formed by various different kinds of elements. In the simplest form, the mounting foot is a flange directly welded to the bottom of the bearing frame 11. A fully integrated and invisible mounting foot is also possible as disclosed in the unpublished European patent application 24160956.9 incorporated herein by reference.

Returning to FIG. 4, the placement of the actuator 4 in the bearing frame 11 will be described. To this end, elongated support members 52 are mounted to the bearing frame 11 using the fixation openings 28. In the illustrated embodiment, an upper pair and a lower pair of openings 28 are used to allow mounting two supports 52 on each wall 37. Fasteners 51 are provided to fasten the supports 52 to the bearing frame 11. These fasteners 51 engage in threaded openings 53 provided in the supports 52. Spring washers 49 are provided on each fastener 51 to reduce the risk of loosening of the fasteners 51 due to actuator vibration.

The support members 52 may be spaced from the walls 37 due to the presence of one or more spacers 54. The spacer 54 may be cut at length from an extrusion profile. The spacer is positioned between the walls 27 and the support members 52 and is fixed by use of the same fasteners 51. The spacers 54 are used to vary the position of the actuator 4 with respect to the bearing frame 11 in the depth direction 17.

The upper housing section 14 of the actuator 4 is provided with elongated slots 55. The support members 52 are received in these slots 55. Prior to tightening the fasteners 51, the supports 52 and slots 55 form an interlock slide (e.g. a T-slot, dovetail, etc.) which allow the actuator 4 to slide with respect to the bearing frame 11 in the width direction 16. Tightening the fasteners 51 prevents such a sliding motion.

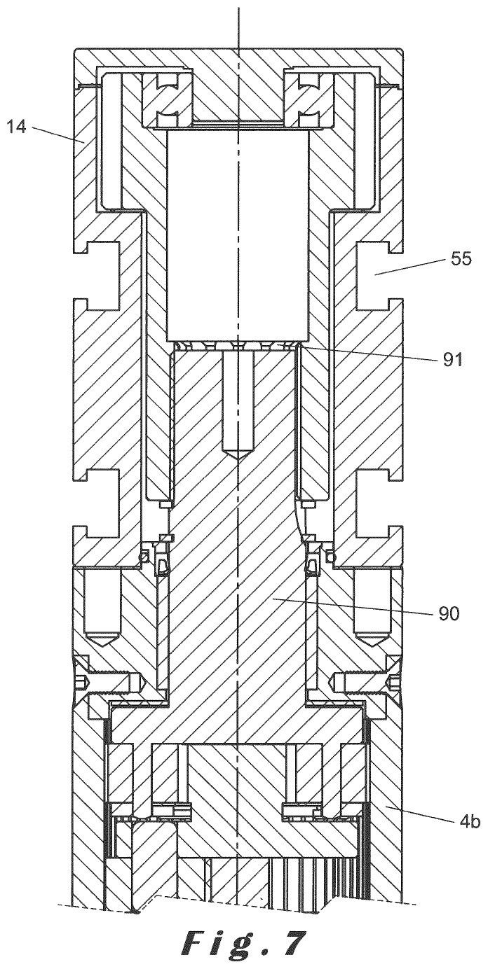

The T-slot shape of the grooves 55 is also clearly shown in FIG. 7. The vertical placement of these grooves 55 is also specifically chosen as being in the upper housing 14 with the actuating mechanism 4a below the grooves 55 and the transmission mechanism 4b above the grooves 55 and also spaced in the width direction 16. This allows to keep the actuator 4 and thus the gate post 2 as compact as possible. For example, if the grooves 55 were surrounding the actuator mechanism 4b, this would lead to an increased thickness or a reduced space for the actuator mechanism 4b which would negatively influence its strength, robustness, operation, etc.

In general, as part of the present invention, the entire closure system 1 may be assembled only by means of threaded fastening members, clip nuts and sawing. Importantly, no welding is required. As such, all gate post components can have its final finish (e.g. powder lack) already applied during the manufacturing process. This gate post 2 can then be shipped together with the gate 3 to the installation site where it may be readily mounted on the ground surface without requiring a skilled technician.

The gate post 2 may comprise one or more cover parts that are shown in FIGS. 3 and 4. The front and back wall 25 are finished by cover profiles 60. Such a cover profile 60 and how it is mounted on the bearing frame 11 is disclosed in detail in the unpublished European patent application 24160956.9 incorporated herein by reference.

A top cover 61 is also provided in the illustrated embodiment. This top cover 61 is mounted by intermediary of a mounting plate 62 to which the top cover 61 is fastened by a threaded fastener 63. The mounting plate 62 has a flange edge 66 with fixation openings 67 that align with fixation openings 28 in the bearing frame 11. Threaded fasteners 68 are used to fix the mounting plate 62 to the bearing frame 11. The top cover 61 also has a flange edge 65 which, as described in unpublished European patent application 24160956.9, covers a top section of the cover profiles 60 to aid in retaining these against the bearing frame 11.

There is also a actuator top cover 70 that is fastened to the actuator 4 by means of a threaded fastener 71 extending through an opening 72 into a threaded area 73 of the actuator 4. The actuator top cover 70 can have the same visual appearance as the other cover elements 60, 61 and/or the gate post 2 and gate 3.

Although aspects of the present disclosure have been described with respect to specific embodiments, it will be readily appreciated that these aspects may be implemented in other forms within the scope of the invention as defined by the claims.

1. A closure system comprising:
a pivotable gate;
a gate post extending in an upright direction between a lower end and an upper end, the gate post comprising:
a mounting foot provided at the lower end of the gate post and being configured to be mounted on a ground surface; and
a bearing frame extending in the upright direction between a lower end and an upper end with the pivotable gate being hingedly connected to the bearing frame, the bearing frame comprising a first set of support members near its upper end and comprising at least two support members which are located on opposite sides of the bearing frame;
an actuator which is at least partially positioned inside the bearing frame, the actuator being mainly L-shaped with a first leg extending in the upright direction between a lower end and an upper end and a second leg extending from the lower end outwards in a transverse direction which is perpendicular to the upright direction, the actuator comprising:
an output member provided in the second leg with the pivotable gate engaging the output member; and
a second set of support members which corresponds to said first set of support members, wherein the actuator is supported inside the bearing frame by intercoupling of the first and second sets of support members.

2. The closure system according to claim 1, wherein the actuator is adjustable with respect to the bearing frame in the transverse direction.

3. The closure system according to claim 2, wherein the first and second sets of support members form a sliding interlock, such as a T-slot or a dovetail, extending in the transverse direction.

4. The closure system according to claim 1, wherein a spacer is provided between the bearing frame and one of said at least two support members, the spacer extending in a direction which is perpendicular to the upright direction and to the transverse direction, the spacer preferably being cut at length from an extrusion profile.

5. The closure system according to claim 1, wherein the actuator is substantially watertight.

6. The closure system according to claim 1, wherein the bearing frame is provided with a plurality of sets of fixation openings, each set being spaced apart from an adjacent set in the upright direction and comprising two groups of openings with each group being provided in an opposite wall of the bearing frame, each group comprising two or more openings which are aligned in the transverse direction.

7. The closure system according to claim 6, wherein the mounting foot and/or the first set of support members are fixed to the bearing frame by a plurality of fixation elements which each extend through one of the fixation openings that are part of said plurality of sets of fixation openings.

8. The closure system according to claim 7, wherein the fixation elements used to fix the first set of support members to the bearing frame are provided with a spring washer.

9. The closure system according to claim 6, wherein each of said plurality of sets of fixation openings are identical and are preferably uniformly distributed along an upwards extending section of the bearing frame.

10. The closure system according to claim 1, wherein the first set of support members comprises at least two support members that are spaced in the upright direction on each of said opposite sides of the bearing frame.

11. The closure system according to claim 1, wherein the actuator comprises:
a drive mechanism forming mainly said first leg, the drive mechanism comprising one of: a spring biased mechanism, a hydraulically damped spring biased mechanism, and an electric motor; and
a transmission forming mainly said second leg.

12. The closure system according to claim 11, wherein the second set of support members are located substantially between the drive mechanism and the transmission mechanism and particularly adjacent an output shaft of the drive mechanism.

13. The closure system according to claim 1, wherein the gate post further comprises: a top cover and/or an actuator top cover.

14. The closure system according to claim 1, wherein:
the pivotable gate is rotatable with respect to the gate post over an angle of at least 150°; and/or
the pivotable gate has a closed position and is rotatable with respect to this closed position in two different rotational directions to two distinct open positions.

15. A method for at least partially assembling closure system according to claim 1, the method comprising:
placing the actuator inside the bearing frame;
sliding the bearing frame over the mounting foot;
using fixation elements to join the mounting foot, the actuator and the bearing frame together to form a gate post; and
providing the gate post and the pivotable gate to be mounted on a ground surface.
